(19) United States
(12) Patent Application Publication
(10) Pub. No.: US 2014/0180582 A1
(43) Pub. Date: Jun. 26, 2014

(54) APPARATUS, METHOD AND TECHNIQUES FOR WEARABLE NAVIGATION DEVICE

(71) Applicants: Mark C. Pontarelli, Escondido, CA (US); Giuseppe Raffa, Portland, OR (US); Mark R. Francis, Portland, OR (US)

(72) Inventors: Mark C. Pontarelli, Escondido, CA (US); Giuseppe Raffa, Portland, OR (US); Mark R. Francis, Portland, OR (US)

(21) Appl. No.: 13/725,526

(22) Filed: Dec. 21, 2012

(51) Int. Cl. G01C 21/00; G08B 6/00

(52) U.S. Cl. CPC G01C 21/00; G08B 6/00
USPC 701/494; 340/407.1

(57) ABSTRACT

An apparatus, method and other techniques for a wearable navigation device are described. For example, an apparatus may comprise a wristband comprising a plurality of haptic feedback devices arranged around a circumference of the wristband and logic to wirelessly receive navigation information from a computing device and to output the navigation information using one or more of the plurality of haptic feedback devices, the output comprising a mechanical representation of the navigation information. Other embodiments are described and claimed.

### BACKGROUND

Modern computing devices continue to evolve in variety of ways. One particular area in which computing devices have evolved is in the area of wearable computing devices that are becoming increasingly popular as stand-alone computing devices and as peripherals used in conjunction with other computing devices. Additionally, many modern computing devices include a plurality of devices and mechanisms enabling on-the-go or mobile functionality. The inclusion of an abundance of features has resulted in an increased reliance upon mobile computing devices for mobile computing tasks such as personal navigation and the like. As the ergonomics and form factor design of computing devices continue to evolve, improvements in user interactions with the devices through the use of wearable or otherwise non-visually-intrusive peripherals become important considerations. As a result, it is desirable to provide a non-visually-intrusive device to supplement mobile computing device functionality. Consequently, there exists a substantial need for an apparatus including a wearable computing device or computing device peripheral. It is with respect to these and other considerations that the embodiments described herein are needed.

### BRIEF DESCRIPTION OF THE DRAWINGS

FIG. 1 illustrates an embodiment of a first system.

FIG. 2 illustrates an embodiment of a second system

FIG. 3A illustrates an embodiment of a first operating environment.

FIG. 3B illustrates an embodiment of a second operating environment.

FIG. 4 illustrates an embodiment of a third operating environment.

FIG. 5 illustrates an embodiment of a fourth operating environment.

FIG. 6A illustrates an embodiment of a first logic flow.

FIG. 6B illustrates an embodiment of a second logic flow.

FIG. 7 illustrates an embodiment of a computing architecture.

### DETAILED DESCRIPTION

Various embodiments are generally directed to an apparatus, method and other techniques for a wearable navigation device or other computing device. Some embodiments are particularly directed to an apparatus comprising a wristband comprising a plurality of haptic feedback devices arranged around a circumference of the wristband and logic to wirelessly receive navigation information from a computing device and to output the navigation information using one or more of the plurality of haptic feedback devices, the output comprising a mechanical representation of the navigation information. Other embodiments are described and claimed.

Navigation and mapping solutions implemented as applications on mobile computing devices are increasingly offering walking, pedestrian, public transportation and other forms of directions. However, for walking directions in particular, these solutions can be awkward given the need to view a screen of the mobile computing device while walking. This may be problematic not only for the user of the mobile computing device who may inadvertently bump into other people, walk into traffic or otherwise injure themself, but also for others who may be disturbed or injured as a result of the user's carelessness. As mobile computing device screens continue to grow in size and the mobility of smartphones, tablets, ultrabook computers, netbook computers and notebook computers continue to increase, the need for alternative user interfaces are increasing as well.

Some embodiments described herein may comprise an active wrist band or other wearable computing device that comprises a segmented series of elements that provide feedback to the wearer in a variety of manners, such as but not limited to vibration, constriction of the wrist, etc. In various embodiments, the wristband may be integrated with an intelligent device like a smart watch or connected as a peripheral to a mobile computing device such as a smartphone, tablet, and/or computer to provide the elements of navigation. The wristband may be operative to interpret these navigation primitives into user feedback such as squeezing or vibrating the inside, outside or circumference of the wrist, for example. This tactile feedback may give the user the ability to navigate unfamiliar territory without the risk and inconvenience of holding a mobile computing device in his/her field of view. Other embodiments are described and claimed.

With general reference to notations and nomenclature used herein, the detailed description that follows may be presented in terms of program procedures executed on a computer or network of computers. These procedural descriptions and representations are used by those skilled in the art to most effectively convey the substance of their work to others skilled in the art.

A procedure is here and is generally conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein that form part of one or more embodiments. Rather, the operations are machine operations. Useful machines for performing operations of various embodiments include general-purpose digital computers or similar devices.

Various embodiments also relate to apparatus or systems for performing these operations. This apparatus may be specially constructed for the required purpose or it may comprise a general-purpose computer as selectively activated or reconfigured by a computer program stored in the computer. The procedures presented herein are not inherently related to a particular computer or other apparatus. Various general-purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

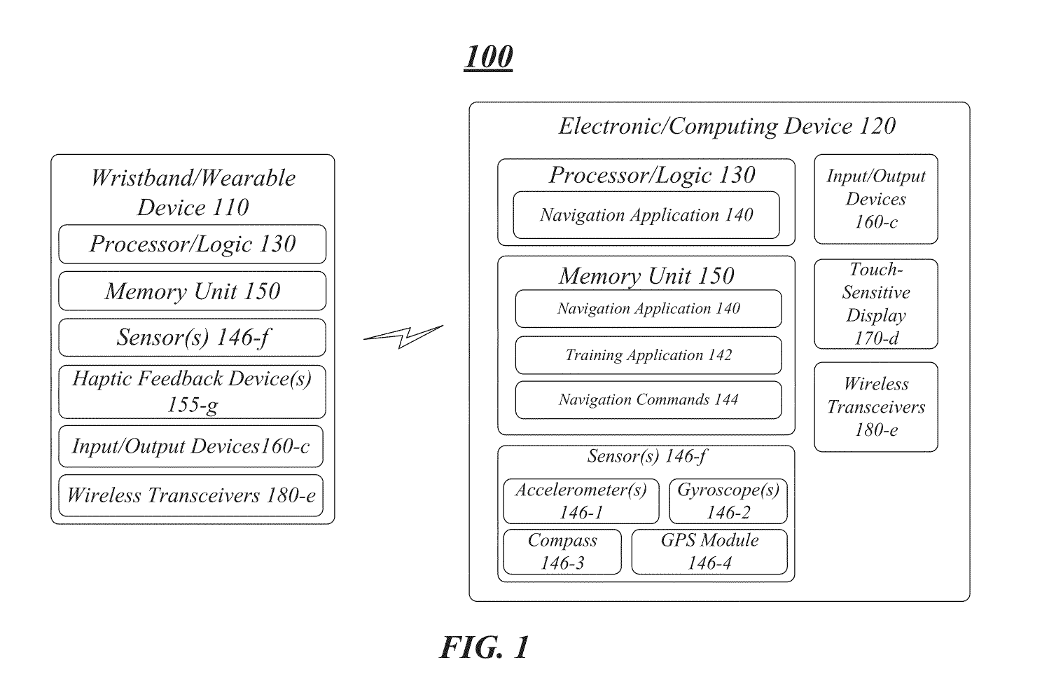

FIG. 1 illustrates a block diagram for a system 100 or an apparatus 100. In one embodiment, the system or apparatus 100 (referred to hereinafter as system 100) may comprise a computer-based system comprising electronic/computing device 110 and electronic/computing device 120. In some embodiments, computing device 110 may comprise a wearable computing device such as but not limited to a wristband while computing device 120 may comprise a smart device such as but not limited to a smart phone, tablet, ultrabook, notebook or other computing device. While referred to hereinafter as a wristband 110 or wearable device 110 for purposes of simplicity and illustration, it should be understood that computing device 110 may comprise any suitable form factor and still fall within the described embodiments.

The computing device 120 may comprise, for example, a processor 130, a memory unit 150, input/output devices 160-c, displays 170-d, one or more transceivers 180-e, and one or more sensors 146-f. In some embodiments, the sensors 146-f may include one or more accelerometers 146-1, gyroscopes 146-2, compass 146-3 and/or Global Positioning System (GPS) module 146-4. The computing device 120 may further have installed or comprise a navigation application 140 and a training application 142. The memory unit 150 may store an unexecuted version of the navigation application 140 and/or the training application 142 and one or more navigation commands 144. While the navigation application 140, training application 142 and navigation commands 144 are shown as separate components or modules in FIG. 1, it should be understood that one or more of the training application 142 and navigation commands 144 could be part of the navigation application 140 and still fall within the described embodiments. Also, although the system 100 shown in FIG. 1 has a limited number of elements in a certain topology, it may be appreciated that the system 100 may include more or less elements in alternate topologies as desired for a given implementation.

Wristband 110 may comprise, for example, a processor/logic 130, a memory unit 150, input/output devices 160-c, one or more transceivers 180-e, one or more sensors 146-f and haptic feedback device(s) 155-g. In some embodiments, the sensors 146-f may include one or more accelerometers 146-1, gyroscopes 146-2, compass 146-3 and/or Global Positioning System (GPS) module 146-4. The haptic feedback device(s) 155-g may comprise one or more vibration devices, compression devices, electroactive polymers, piezoelectric devices, electrostatic devices, or subsonic audio wave surface actuation devices. Like elements are similarly numbered for wristband 110 and computing device 120.

In various embodiments, the wristband 110 and the computing device 120 may be wirelessly coupled and the wristband 110 may be arranged to wirelessly receive navigation information from the computing device 120 and to output the navigation information using one or more of the plurality of haptic feedback devices 155-g. In some embodiments, the output may comprise a mechanical representation of the navigation information. Other embodiments are described and claimed.

It is worthy to note that “a” and “b” and “c” and similar designators as used herein are intended to be variables representing any positive integer. Thus, for example, if an implementation sets a value for e=5, then a complete set of wireless transceivers 180 may include wireless transceivers 180-1, 180-2, 180-3, 180-4 and 180-5. The embodiments are not limited in this context.

In various embodiments, the system 100 may comprise or include wristband, wearable device and/or computing device 110 (hereinafter wristband 110). Some examples of wristband 110 may comprise a computing device arranged or operative to be worn on or by a user of the wristband 110. Wristband 110 may comprise one or more encircling strips or segments worn on the wrist of a user. In some embodiments, wristband 110 may comprise any suitable material such as but no limited to rubber, plastic or metal. Wristband 110 may comprise a watch-like or bracelet-like device that is arranged to enclose, support and/or protect a plurality of components to enable the wristband 110 to act as a haptic feedback navigation device.

The system 100 may also comprise or include computing device 120 in some embodiments. Some examples of a computing device may include without limitation an ultra-mobile device, a mobile device, a personal digital assistant (PDA), a mobile computing device, a smart phone, a telephone, a digital telephone, a cellular telephone, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, machine, or combination thereof. The embodiments are not limited in this context.

In various embodiments, wristband 110 and/or computing device 120 of the system 100 may comprise logic and/or a processor 130. The processor 130 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Core (2) Quad®, Core i3®, Core i5®, Core i7®, Atom®, Itanium®, Pentium®, Xeon®, and XScale® processors; and similar processors. Dual microprocessors, multi-core processors, and other multi-processor architectures may also be employed as the processing 130.

In various embodiments, wristband and/or computing device 120 of the system 100 may comprise a memory unit 150. The memory unit 150 may store, among other types of information, the navigation application 140, training application 142 and/or navigation commands 144. The memory unit 150 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

In some embodiments, the wristband 110 and/or computing device 120 may comprise one or more input/output devices 160-c. The one or more input/output devices 160-c may be arranged to provide functionality to the wristband 110 and/or computing device 120 including but not limited to capturing images, exchanging information, capturing or reproducing multimedia information, receiving user feedback, or any other suitable functionality. Non-limiting examples of input/output devices 160-c include a camera, QR reader/writer, bar code reader, buttons, switches, input/output ports such as a universal serial bus (USB) port, touch-sensitive sensors, pressure sensors, a touch-sensitive digital display and the like. The embodiments are not limited in this respect.

The wristband 110 and/or computing device 120 may comprise one or more displays 170-d in some embodiments. The displays 170-d may comprise any digital display device suitable for the electronic devices 120. For instance, the displays 170-d may be implemented by a liquid crystal display (LCD) such as a touch-sensitive, color, thin-film transistor (TFT) LCD, a plasma display, a light emitting diode (LED) display, an organic light emitting diode (OLED) display, a cathode ray tube (CRT) display, or other type of suitable visual interface for displaying content to a user of the wristband 110 and/or computing devices 120. The displays 170-d may further include some form of a backlight or brightness emitter as desired for a given implementation.

In various embodiments, the displays 170-d may comprise touch-sensitive or touchscreen displays. A touchscreen may comprise an electronic visual display that is operative to detect the presence and location of a touch within the display area or touch interface. In some embodiments, the display may be sensitive or responsive to touching of the display of the device with a finger or hand. In other embodiments, the display may be operative to sense other passive objects, such as a stylus or electronic pen. In various embodiments, displays 170-d may enable a user to interact directly with what is displayed, rather than indirectly with a pointer controlled by a mouse or touchpad. Other embodiments are described and claimed.

The wristband 110 and/or computing device 120 may comprise one or more wireless transceivers 180-e in some embodiments. Each of the wireless transceivers 180-e may be implemented as physical wireless adapters or virtual wireless adapters sometimes referred to as “hardware radios” and “software radios.” In the latter case, a single physical wireless adapter may be virtualized using software into multiple virtual wireless adapters. A physical wireless adapter typically connects to a hardware-based wireless access point. A virtual wireless adapter typically connects to a software-based wireless access point, sometimes referred to as a “SoftAP.” For instance, a virtual wireless adapter may allow ad hoc communications between peer devices, such as a smart phone and a desktop computer or notebook computer. Various embodiments may use a single physical wireless adapter implemented as multiple virtual wireless adapters, multiple physical wireless adapters, multiple physical wireless adapters each implemented as multiple virtual wireless adapters, or some combination thereof. The embodiments are not limited in this case.

The wireless transceivers 180-e may comprise or implement various communication techniques to allow the wristband 110 and the computing device 120 to communicate with each other and/or with other electronic devices. For instance, the wireless transceivers 180-e may implement various types of standard communication elements designed to be interoperable with a network, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

In various embodiments, the wristband 110 and/or computing device 120 may implement different types of wireless transceivers 180-e. Each of the wireless transceivers 180-e may implement or utilize a same or different set of communication parameters to communicate information between various electronic devices. In one embodiment, for example, each of the wireless transceivers 180-e may implement or utilize a different set of communication parameters to communicate information between wristband 110 and computing device 120 and any number of other devices. Some examples of communication parameters may include without limitation a communication protocol, a communication standard, a radio-frequency (RF) band, a radio, a transmitter/receiver (transceiver), a radio processor, a baseband processor, a network scanning threshold parameter, a radio-frequency channel parameter, an access point parameter, a rate selection parameter, a frame size parameter, an aggregation size parameter, a packet retry limit parameter, a protocol parameter, a radio parameter, modulation and coding scheme (MCS), acknowledgement parameter, media access control (MAC) layer parameter, physical (PHY) layer parameter, and any other communication parameters affecting operations for the wireless transceivers 180-e. The embodiments are not limited in this context.

In various embodiments, the wireless transceivers 180-e may implement different communication parameters offering varying bandwidths, communications speeds, or transmission range. For instance, a first wireless transceiver 180-1 may comprise a short-range interface implementing suitable communication parameters for shorter range communications of information, while a second wireless transceiver 180-2 may comprise a long-range interface implementing suitable communication parameters for longer range communications of information.

In various embodiments, the terms “short-range” and “long-range” may be relative terms referring to associated communications ranges (or distances) for associated wireless transceivers 180-e as compared to each other rather than an objective standard. In one embodiment, for example, the term “short-range” may refer to a communications range or distance for the first wireless transceiver 180-1 that is shorter than a communications range or distance for another wireless transceiver 180-e implemented for the electronic device 120, such as a second wireless transceiver 180-2. Similarly, the term “long-range” may refer to a communications range or distance for the second wireless transceiver 180-2 that is longer than a communications range or distance for another wireless transceiver 180-e implemented for the electronic device 120, such as the first wireless transceiver 180-1. The embodiments are not limited in this context.

In various embodiments, the terms “short-range” and “long-range” may be relative terms referring to associated communications ranges (or distances) for associated wireless transceivers 180-e as compared to an objective measure, such as provided by a communications standard, protocol or interface. In one embodiment, for example, the term “short-range” may refer to a communications range or distance for the first wireless transceiver 180-1 that is shorter than 300 meters or some other defined distance. Similarly, the term “long-range” may refer to a communications range or distance for the second wireless transceiver 180-2 that is longer than 300 meters or some other defined distance. The embodiments are not limited in this context.

In one embodiment, for example, the wireless transceiver 180-1 may comprise a radio designed to communicate information over a wireless personal area network (WPAN) or a wireless local area network (WLAN). The wireless transceiver 180-1 may be arranged to provide data communications functionality in accordance with different types of lower range wireless network systems or protocols. Examples of suitable WPAN systems offering lower range data communication services may include a Bluetooth system as defined by the Bluetooth Special Interest Group, an infra-red (IR) system, an Institute of Electrical and Electronics Engineers (IEEE) 802.15 system, a DASH7 system, wireless universal serial bus (USB), wireless high-definition (HD), an ultra-side band (UWB) system, and similar systems. Examples of suitable WLAN systems offering lower range data communications services may include the IEEE 802.xx series of protocols, such as the IEEE 802.11a/b/g/n series of standard protocols and variants (also referred to as “WiFi”). It may be appreciated that other wireless techniques may be implemented, and the embodiments are not limited in this context.

In one embodiment, for example, the wireless transceiver 180-2 may comprise a radio designed to communicate information over a wireless local area network (WLAN), a wireless metropolitan area network (WMAN), a wireless wide area network (WWAN), or a cellular radiotelephone system. The wireless transceiver 180-2 may be arranged to provide data communications functionality in accordance with different types of longer range wireless network systems or protocols. Examples of suitable wireless network systems offering longer range data communication services may include the IEEE 802.xx series of protocols, such as the IEEE 802.11a/b/g/n series of standard protocols and variants, the IEEE 802.16 series of standard protocols and variants, the IEEE 802.20 series of standard protocols and variants (also referred to as “Mobile Broadband Wireless Access”), and so forth. Alternatively, the wireless transceiver 180-2 may comprise a radio designed to communication information across data networking links provided by one or more cellular radiotelephone systems. Examples of cellular radiotelephone systems offering data communications services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, High Speed Uplink Packet Access (HSUPA), and similar systems. It may be appreciated that other wireless techniques may be implemented, and the embodiments are not limited in this context.

In various embodiments, sensors 146-f may comprise any combination of sensors capable of determining or detecting an orientation, location and/or movement of wristband 110 and/or computing device 120. For example, in some embodiments the sensors 146-f may comprise one or more accelerometers 146-1, one or more gyroscopes 146-2, a compass 146-2 and/or a GPS module 146-4. Any suitable type of sensor could be used and still fall within the described embodiments as one skilled in the art would readily understand. In some embodiments, the accelerometer 146-1 and/or gyroscope 146-2 may comprise or be implemented using microelectromechanical systems (MEMS) technology. The embodiments are not limited in this respect.

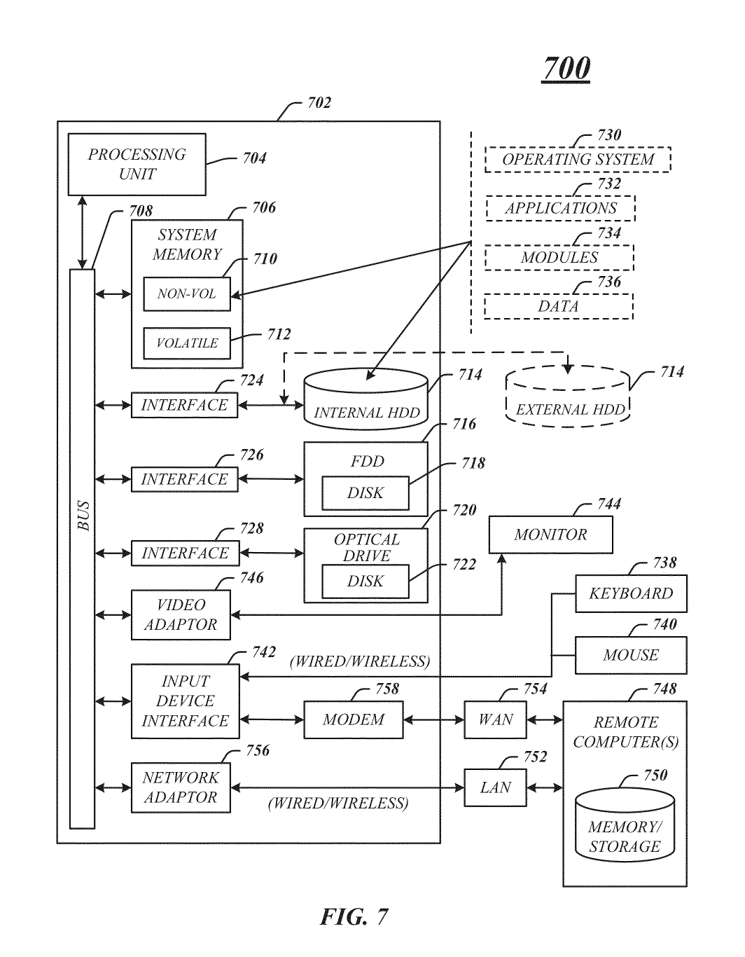

Although not shown, the wristband 110 and/or computing device 120 may further comprise one or more device resources commonly implemented for electronic devices, such as various computing and communications platform hardware and software components typically implemented by a personal electronic device. Some examples of device resources may include without limitation a co-processor, a graphics processing unit (GPU), a chipset/platform control hub (PCH), an input/output (I/O) device, computer-readable media, display electronics, display backlight, network interfaces, location devices (e.g., a GPS receiver), sensors (e.g., biometric, thermal, environmental, proximity, accelerometers, barometric, pressure, etc.), portable power supplies (e.g., a battery), application programs, system programs, and so forth. Other examples of device resources are described with reference to exemplary computing architectures shown by FIG. 7. The embodiments, however, are not limited to these examples.

In the illustrated embodiment shown in FIG. 1, the processor 130 may be communicatively coupled to the wireless transceivers 180-e and the memory unit 150. The memory unit 150 may store the navigation application 140 and the training application 142 arranged for execution by the processor 130 to enable navigation. The navigation application 140 may generally provide features to enable the monitoring of movement and location and to provide feedback to enable guided movement from one place to another. The training application 142 may generally provide features to enable the programming of navigation commands 144 and other information to/from wristband 110. Other embodiments are described and claimed.

While various embodiments described herein include separate devices including wristband 110 and computing device 120, it should be understood that some or all of the functionality described as being implemented by wristband 110 and/or computing device 120 can additionally or alternatively be implemented by the other device. For example, while navigation application 140 is show in FIG. 1 as being part of or implemented by computing device 120, in some embodiments, navigation application 140 may be implemented by wristband 110. The embodiments are not limited in this respect.

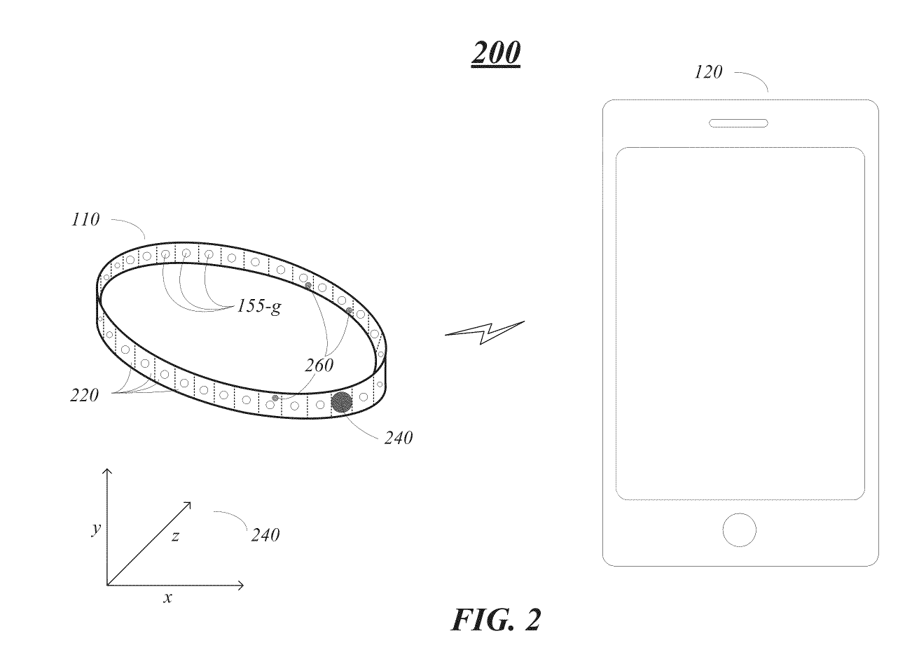

FIG. 2 illustrates a block diagram for a system 200. In some embodiments, the system 200 may represent a portion of system 100 of FIG. 1. For example, system 200 may comprise a physical representation of one embodiment of a wristband 110 and a computing device 120 of FIG. 1. While not shown in FIG. 2, the wristband 110 and computing device 120 may include the same or similar components to the wristband 110 and computing device 120 of FIG. 1.

In various embodiments, the wristband 110 may comprise a plurality of haptic feedback devices 155-g arranged around a circumference of the wristband 110 or substantially around the circumference of the wristband. The plurality of haptic feedback devices 155-g may comprise one or more vibration devices, compression devices, electroactive polymers, piezoelectric devices, electrostatic devices, or subsonic audio wave surface actuation devices. The plurality of haptic feedback devices 155-g may be arranged or implemented using any suitable tactile feedback technology that takes advantage of the sense of touch by applying forces, vibrations, or motions to the user. In some embodiments, the plurality of haptic feedback devices 155-g may be communicatively coupled together using one or more flexible or flex circuits and enclosed in one or more cavities defined by an inner dimension of the wristband 110.

The wristband 110 comprises a plurality of segments 220 arranged to individually enclose each of the plurality of haptic feedback devices 155-g in some embodiments. The plurality of segments 220 may define cavities or enclosure spaces to house the components of wristband 110, including the plurality of haptic feedback devices 155-g, and the segments 220 may be coupled together to allow the wristband 110 to flex between the plurality of segments 220 in various embodiments. While described herein in terms of a plurality of segments 220, it should be understood that the wristband 110 could be constructed using different techniques and still fall within the described embodiments. For example, the wristband 110 may comprise a smooth or textured surface instead of the plurality of segments 220.

The wristband 110 may be designed to flex, stretch or otherwise adapt to the shape of a user's wrist in various embodiments. In other embodiments, the wristband 110 may be adjustable (e.g. like a watch band) to accommodate different users. While shown and described as comprising a closed loop, it should be understood that the wristband 110 may comprise other configurations and still fall within the described embodiments. For example, the wristband 110 may be formed in a clasp-like or bangle-like manner where opposing ends of the wristband 110 may not be permanently connected. In other embodiments, the opposing ends of the wristband 110 may not be permanently connected, but may be removably connected or coupled by a magnet or other suitable attachment or closure device. In further embodiments, the wristband 110 may be designed to mechanically form into a shape designed to accommodate the wrist of a user, and my include sufficiently flexibility to allow a user to easily place the wristband 110 on their wrist, while then returning to its original shape. The embodiments are not limited in this respect.

In various embodiments, wristband 110 may include or comprise logic to wirelessly receive navigation information from a computing device and to output the navigation information using one or more of the plurality of haptic feedback devices 155-g. For example, the wristband 110 may be operative to wirelessly receive navigation information from computing device 120 in some embodiments. In other embodiments, the navigation information may be generated by or may originate from the wristband 110. In either case, the navigation information may comprise directional or movement information related to a path from one place to another. For example, the navigation information may comprise directions from a first location to a second location, including various turns, obstacles, waypoints, etc. in between. While described herein in terms of navigation information, it should be understood that any type of information that could benefit from haptic feedback could be used and still fall within the described embodiments.

The wristband 110 may be arranged to output a mechanical representation of the navigation information using the plurality of haptic feedback devices 155-g in some embodiments. For example, the mechanical representation of the navigation information may comprise a selective activation of a predetermined group (e.g. one or more) of the plurality of haptic feedback devices 155-g, a predetermined pattern of activation of one or more of the plurality of haptic feedback devices 155-g or the like. In various embodiments, the logic may be operative to control the plurality of haptic feedback devices 155-g individually or as a group to output different navigation commands based on the received navigation information.

The mechanical representation of the navigation information may comprise vibration or other activation of the one or more haptic feedback devices 155-g. In various embodiments, the logic may be operative to increase or decrease a frequency or intensity of the mechanical representation of the navigation information based on one or more navigation attributes of the navigation information. The navigation attributes may comprise information related to one or more steps or portions of a navigation path. For example, the navigation attributes may comprise a distance before a next navigation action will be required, such as a turn, a change of paths, a change of direction, a stopping action, etc. Other embodiments are described and claimed.

In some embodiments, wristband 110 may include one or more input/output (I/O) devices 240 to control the wristband 110. For example, the one or more I/O devices 240 may comprise a button, switch, or touch-sensitive portion of wristband 110 operative to initiate or terminate navigation, to accept or dismiss navigation information, or to receive training input information, the one or more I/O devices comprising a mechanical input device, touch input device, gesture input device or voice input device. The embodiments are not limited in this respect.

Wristband 110 may include one or more orientation devices 260 in various embodiments. The one or more orientation devices 260 may comprise one or more of an accelerometer, a gyroscope or a compass in some embodiments. While a limited number, type and configuration of orientation devices 260 is shown in FIG. 2 for purposes of illustration, it should be understand that the embodiments are not limited in this respect. In various embodiments, the logic of wristband 110 may be operative to dynamically determine an orientation of the wristband 110 in three-dimensional (3D) space, represented for example by axis's 240, using orientation information received from the one or more orientation devices 260. For example, as user moves about, the location and position of wristband 110 will change over time. To accommodate for this movement, the logic of wristband 110 may be operative to dynamically update the one or more haptic feedback devices 155-g used to output the navigation information based on changes in the orientation of the wristband 110.

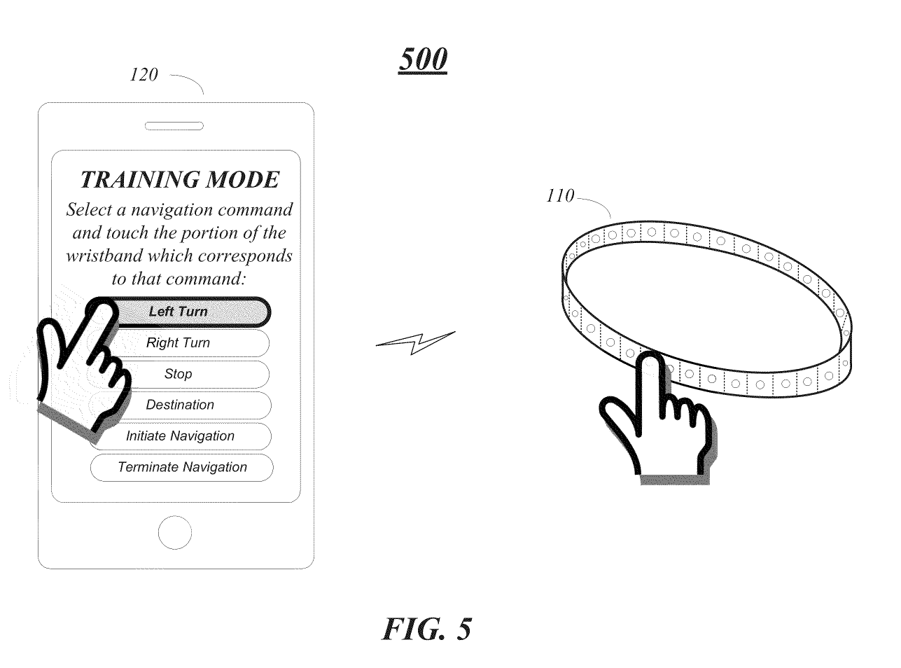

In some embodiments, the logic of wristband 110 may be operative to wireless receive training information from the computing device 120. For example, the training information may comprise mechanical representations of navigation information corresponding to navigation commands that are selected, defined or preferred by a user or they may comprise pre-defined commands. The training information and training process is described in more detail with reference to FIG. 5.

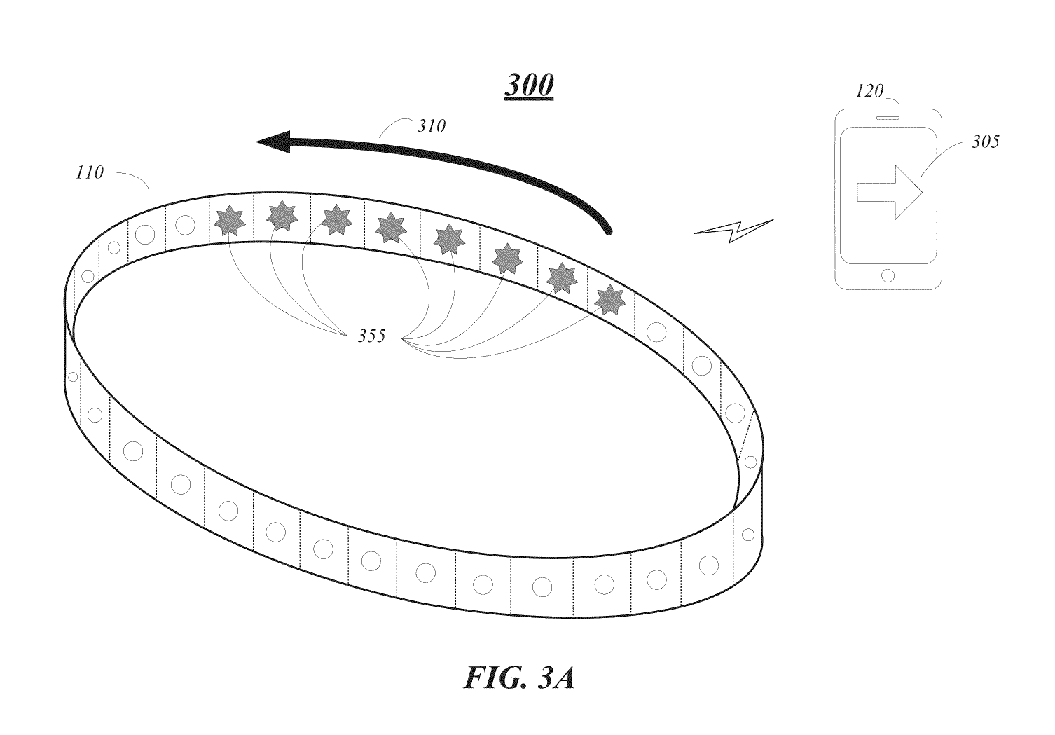

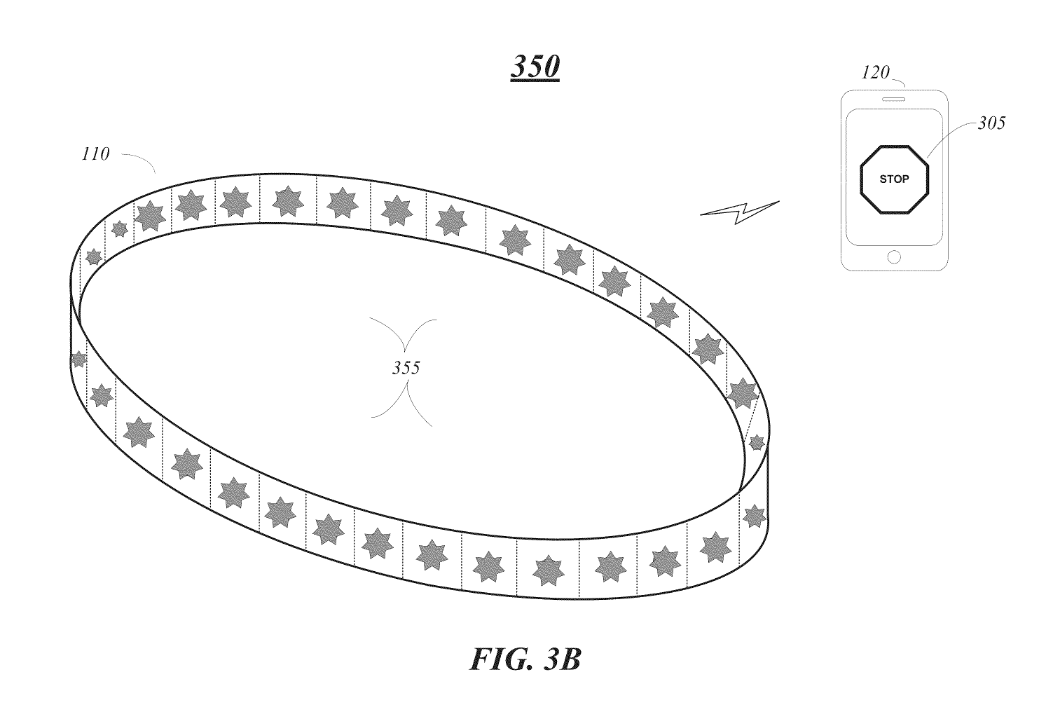

FIG. 3A illustrates an embodiment of a first operating environment 300 for the systems 100 and/or 200. More particularly, the operating environment 300 may illustrate the execution of a navigation command by systems 100 and/or 200. As shown in FIG. 3A, electronic device 120 may execute a navigation application that includes one or more navigation commands 305 as part of a navigation route. In the example shown, the navigation command 305 may comprise RIGHT TURN, which may be representative of an action required to remain on the selected navigation route. In some embodiments, this navigation command 305 may be wireless transmitted to wristband 110 which in turn may be operative to interpret the navigation command 305 or other navigation information and output the navigation command 305 using a group or set of haptic feedback devices 355 that are selected for activation to convey the navigation command 305 using haptic feedback.

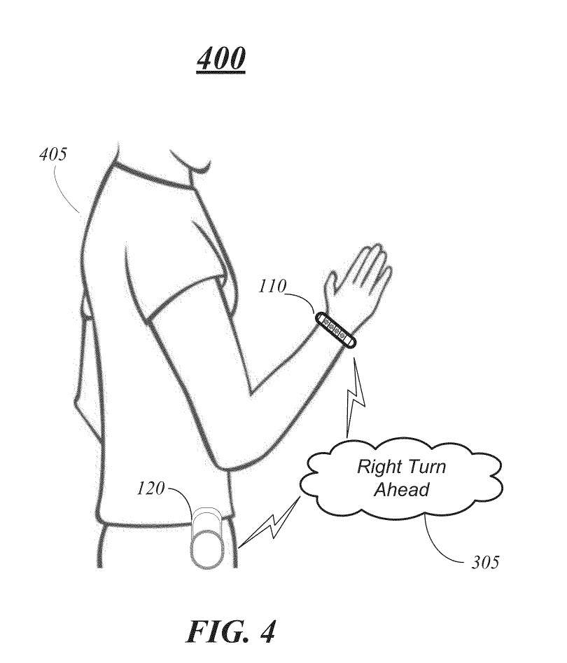

The group of haptic feedback devices 355 may be selected to allow a user to understand the navigation command 305 without having to look at the computing device 120. For example, if a user is wearing the wristband 110 on their right wrist and is walking with their arms swinging by theirs sides in a normal fashion, the wristband 110 may activate a group of haptic feedback devices 355 on the outside of the users right wrist to indicate that a right turn is needed or will be needed to continue to follow the selected navigation route, as illustrated in FIG. 4.

In various embodiments, the activation of one or more of the haptic feedback devices 155-g may be varied to convey information. For example, the logic of wristband 110 may be operative to control the plurality of haptic feedback devices 155-g individually or as a group to output different navigation commands based on the received navigation information. In other embodiments, the logic may be operative to increase or decrease a frequency or intensity of the mechanical representation of the navigation information based on one or more navigation attributes of the navigation information. For example, the logic may be operative to activate a selected group of haptic feedback devices 355 as shown in FIG. 3A. In some embodiments, the group of haptic feedback devices 355 may be activated simultaneously or sequentially. The sequential activation, indicated by arrow 310, may be beneficial in that it may convey additional information such as an intended direction of movement. The embodiments are not limited in this respect.

In various embodiments, the timing of the activation of the group of haptic feedback devices 355 may additional or alternatively be used to convey navigation information. For example, the group of haptic feedback devices 355 may be activated for a different duration based on a time or distance until the action represented by the activation will be needed. In some embodiments, the group of haptic feedback devices 355 may be periodically activated, with a period between instances of activation being varied to convey information. For example, the group of haptic feedback devices 355 may be activated more frequently with smaller periods of time between activation as a waypoint approaches or a time to perform a navigation action nears.

FIG. 3B illustrates an embodiment of a second operating environment 350 for the systems 100 and/or 200. More particularly, the operating environment 350 may illustrate the execution of a navigation command by systems 100 and/or 200, similar to FIG. 3A, which includes one or more navigation commands 305 as part of a navigation route. In the example shown in FIG. 3B, the navigation command 305 may comprise a STOP command, which may be representative of an instruction for the user of wristband 110 to stop or otherwise discontinue motion. In some embodiments, this navigation command 305 may be wireless transmitted to wristband 110 which in turn may be operative to interpret the navigation command 305 or other navigation information and output the navigation command 305 using a group or set of haptic feedback devices 355 that are selected for activation to convey the navigation command 305 using haptic feedback.

In the embodiment show in FIG. 3B, the group of haptic feedback devices 355 may comprise all or substantially all of the haptic feedback devices 155-g. In this example, all of the haptic feedback devices 155-g may be periodically activated to indicate an upcoming stop. For example, the upcoming stop may be associated with arriving at an intended destination. All of the haptic feedback devices 155-g may be activated in a flashing pattern and the frequency of the activation may increase until a solid and continuous activation indicates that the user should stop. Other embodiments are described and claimed.

A limited number and type of navigation commands 305 and haptic feedback device 155-g groups are shown for purposes of illustration and not limitation. One skilled in the art will readily understand that any type of feedback or command could be used and still fall within the described embodiments. Similarly, any combination, sequence, period, frequency, etc. of activation could be used and fall within the described embodiments. As such, the embodiments are not limited to the examples described herein.

FIG. 4 illustrates an embodiment of a third operating environment 400 for the systems 100 and/or 200. More particularly, the operating environment 400 may illustrate and example of a user 405 in control of computing device 120 who is wearing wristband 110. As shown in FIG. 4, while wearing the wristband 110, the user 405 may be able to store the computing device 120 while continuing to receive navigation commands 305 by way of haptic feedback provided by wristband 110. In the example shown, the user 405 has placed the computing device 120 in her pocket, allowing the user to walk on a navigation route without being forced to look at the screen of her computing device 120. In other embodiments, the user 405 may optionally stow the computing device 120 in a backpack, suitcase or other suitable location while continuing to receive the necessary navigation feedback information. Other embodiments are described and claimed.

While described herein in terms of haptic feedback, it should be understood that wristband 110 and/or computing device 120 may be operative to additionally or alternatively provide other forms of feedback. For example, while not shown, wristband 110 may additionally include audio I/O devices in some embodiments. The audio I/O devices may comprise one or more speaker and microphones in some embodiments. In various embodiments, the speakers may be used to output (e.g. spoken word) the navigation commands in conjunction with the haptic feedback while the microphones may be operative to accept speech input and relay this input wherein the wristband 110 is operative to act based on the speech input or to transmit the input to the computing device 120. In other embodiments, the wristband may include one or more lights or light emitting diodes (LEDs) operative to supplement (e.g. visually) the haptic navigation output. Other embodiments are described and claimed.

FIG. 5 illustrates an embodiment of a fourth operating environment 500 for the systems 100 and/or 200. More particularly, the operating environment 500 may illustrate one example of a training mode for the wristband 110 and computing device 120. In various embodiments, the logic of wristband 110 may be operative to wireless receive training information from the computing device 120 as part of, for example, training application 142. In some embodiments, the training information may comprise mechanical representations of navigation information corresponding to navigation commands to allow customization or adaptation of the features provided by wristband 110.

As shown in FIG. 5, a training application 142 may be operative on computing device 120 and may be arranged to allow a user to select options for or customize the output of, interaction with or status of wristband 110. For example, while in the training mode, a user may select a particular action, such as LEFT TURN as shown in FIG. 5. Based on this selection while in training mode, the user may be prompted to touch a portion or portions of wristband 110 that are arranged with one or more touch sensitive elements to indicate which portions of wristband 110 should be activated when the selected command (e.g. LEFT TURN) is sent to wristband 110. In other embodiments, no interaction with wristband 110 may be required and a selection may be made entirely on computing device 120. The embodiments are not limited in this respect.

In some embodiments, the training mode may allow for the selection of a preferred configuration for wristband 110. For example, if a user typically wears the wristband 110 on their right wrist, this information may be stored by computing device 120 and may reduce the calculations required to determine a default or current orientation of the wristband 110 and may also simply the rendering of any commands based on the configuration of wristband 110. In other embodiments, a user may enable or disable features of wristband 110 while in the training mode. For example, a user may select different types of notifications, different times for notifications based on upcoming events and the like. A limited number and type of training examples are provided herein for purposes of illustration and not limitation.

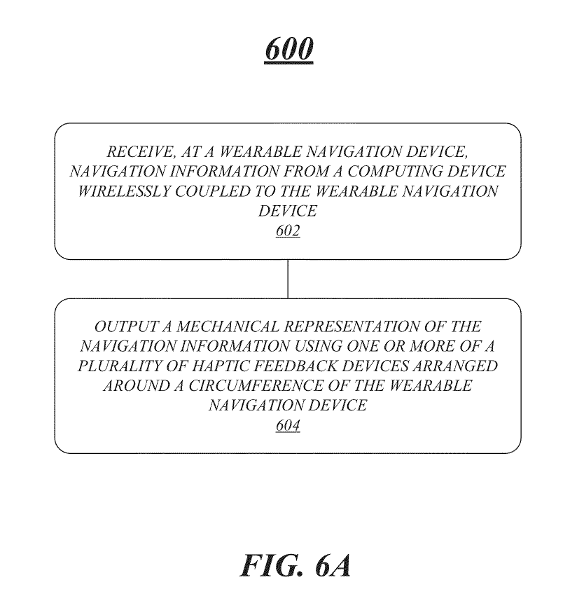

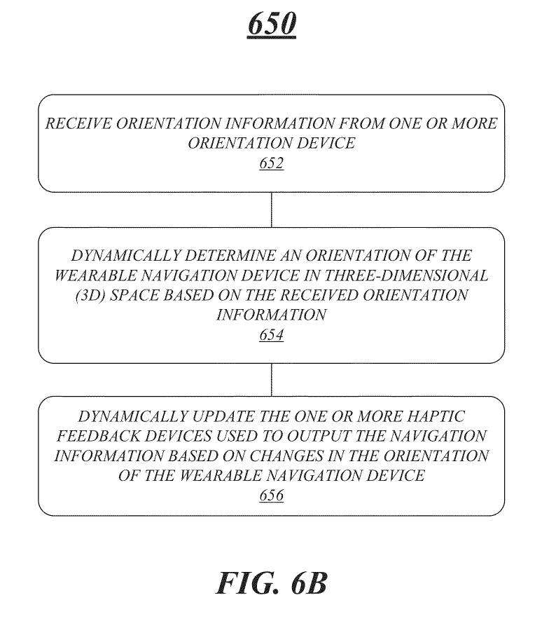

FIG. 6A illustrates one embodiment of a first logic flow 600. The logic flow 600 may be representative of some or all of the operations executed by one or more embodiments described herein. For example, the logic flow 600 may illustrate operations performed by the systems 100/200 and, more particularly, a wristband 110 and/or computing device 120 of systems 100/200.

In the illustrated embodiment shown in FIG. 6A, the logic flow 600 may include receiving, at a wearable navigation device, navigation information from a computing device wirelessly coupled to the wearable navigation device at 602. For example, wristband 110 may be operative to wireless receive, over a Bluetooth or other wireless connection for example, navigation information from computing device 120 which may comprise a smartphone under the control of the user wearing the wristband 110. At 604, in some embodiments, a mechanical representation of the navigation information may be output using one or more of a plurality of haptic feedback devices arranged around a circumference of the wearable navigation device. For example, one or more of the plurality of feedback devices 155-g of wristband 110 may provide haptic feedback to a user to mechanically convey navigation commands associated with the navigation information.

FIG. 6B illustrates one embodiment of a second logic flow 650. The logic flow 650 may be representative of some or all of the operations executed by one or more embodiments described herein. For example, the logic flow 650 may illustrate operations performed by the systems 100/200 and, more particularly, a wristband 110 and/or computing device 120 of the systems 100/200.

In the illustrated embodiment shown in FIG. 6B, the logic flow 650 may comprise receiving orientation information from one or more orientation devices at 652. For example, wristband 110 may include one or more orientation devices such as an accelerometer, a gyroscope or a compass that may be used to detect orientation information. At 654, in some embodiments, an orientation of the wearable navigation device may be dynamically determined in three-dimensional (3D) space based on the received orientation information. For example, logic of wristband 110 may be operative to determine a relative orientation of the wristband based on the information received from the orientation devices.

In various embodiments, the one or more haptic feedback devices used to output the navigation information may be dynamically updated based on changes in the orientation of the wearable navigation device at 656. For example, a first set of the plurality of haptic feedback devices 155-g may be used to output a first command while the wristband is in a first position, but when the wristband 110 changes locations in 3D space to a second and subsequent positions, the group of haptic feedback devices 155-g used to output the first command may be changed to accommodate changes in the relative orientation of the wristband 110. In this manner, for example, a right turn may always be indicated by a group of haptic feedback devices 155-g that are positioned or located on or adjacent to a right side the user, minimizing confusion for the user.

In various embodiments, the plurality of haptic feedback devices may be controlled individually or as a group to output different navigation commands based on the received navigation information. For example, a group of haptic feedback devices 155-g of wristband 110 may be operated to indicate a first action or navigation command, while a second different group of haptic feedback devices 155-g may be operated to indicate a second different action or navigation command.

A frequency or intensity of the mechanical representation of the navigation information may be dynamically increased or decreased based on one or more navigation attributes of the navigation information in some embodiments. For example, the navigation attributes may comprise information related to one or more steps or portions of a navigation path or route such as a distance or time before a next navigation action will be required, such as a turn, a change of paths, a change of direction, a stopping action, etc. In some embodiments, a frequency and/or intensity of activation of the haptic feedback devices 155-g may increase to indicate, for example, an immediacy of an action.

In some embodiments, navigation information indicating that an action is required may be received and one or more of the plurality of haptic feedback devices may be simultaneously or sequentially activated to indicate what action is required. This activation may be periodically replayed or repeated until the action is required and a time between the periodic replaying may be decreased until the action is imminent. Similarly, navigation information may be received indicating that an action is required and one or more of the plurality of haptic feedback devices may be simultaneously or sequentially activated to indicate what action is required. This activation may be periodically replayed or repeated until the action is required and an intensity of the activation may be dynamically increased until the action is imminent. Other embodiments are described and claimed.

In various embodiments, training information may be received from the computing device and a mechanical representation of the navigation information may be updated based on the received training information. For example, computing device 120 and wristband 110 may be updated, customized or otherwise controlled through use of a training application 142 as shown and described with reference to FIG. 5.

A determination may be made in some embodiments that navigation information from the computing device is temporarily unavailable. For example, a user may enter a tunnel where a GPS signal is not available. In these instances, an outstanding navigation command may be output based on dead reckoning information received from a dead reckoning device. For example, wristband 110 may be operative to act as a dead reckoning device such as a pedometer or the like in some embodiments. Based on this capability, wristband 110 may be operative to continue to track navigation, distance and/or time information even in instances when navigation information is not available from computing device 120. The embodiments are not limited in this respect.

FIG. 7 illustrates an embodiment of an exemplary computing architecture 700 suitable for implementing various embodiments as previously described. In one embodiment, the computing architecture 700 may comprise or be implemented as part of wristband 110 and/or computing device 120.

As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 comprises a processing unit 704, a system memory 706 and a system bus 708. The processing unit 704 can be any of various commercially available processors, such as those described with reference to the processor 130 shown in FIG. 1.

The system bus 708 provides an interface for system components including, but not limited to, the system memory 706 to the processing unit 704. The system bus 708 can be any of several types of bus structure that may further interconnect to a memory bus (with or without a memory controller), a peripheral bus, and a local bus using any of a variety of commercially available bus architectures. Interface adapters may connect to the system bus 708 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 700 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media in the form of one or more lower speed memory units, including an internal (or external) hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. In one embodiment, the one or more application programs 732, other program modules 734, and program data 736 can include, for example, the various applications and/or components of the system 100.

A user can enter commands and information into the computer 702 through one or more wire/wireless input devices, for example, a keyboard 738 and a pointing device, such as a mouse 740. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 704 through an input device interface 742 that is coupled to the system bus 708, but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. The monitor 744 may be internal or external to the computer 702. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.11 over-the-air modulation techniques). This includes at least WiFi (or Wireless Fidelity), WiMax, and Bluetooth™ wireless technologies, among others. Thus, the communication can be a predefined structure as with a conventional network or simply an ad hoc communication between at least two devices. WiFi networks use radio technologies called IEEE 802.11x (a, b, g, n, etc.) to provide secure, reliable, fast wireless connectivity. A WiFi network can be used to connect computers to each other, to the Internet, and to wire networks (which use IEEE 802.3-related media and functions).

The various elements of the touch gesture gesture recognition system 100 as previously described with reference to FIGS. 1-7 may comprise various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The detailed disclosure now turns to providing examples that pertain to further embodiments. Examples one through thirty (1-30) provided below are intended to be exemplary and non-limiting.

In a first example, an apparatus may comprise a wristband comprising a plurality of haptic feedback devices arranged around a circumference of the wristband and logic to wirelessly receive navigation information from a computing device and to output the navigation information using one or more of the plurality of haptic feedback devices, the output comprising a mechanical representation of the navigation information.

In a second example, the apparatus may comprise one or more orientation devices, the logic to dynamically determine an orientation of the wristband in three-dimensional (3D) space using orientation information received from the one or more orientation devices.

In a third example, the apparatus may comprise logic to dynamically update the one or more haptic feedback devices used to output the navigation information based on changes in the orientation of the wristband.

In a fourth example, the one or more orientation devices may comprise one or more of an accelerometer, a gyroscope or a compass.

In a fifth example, the plurality of haptic feedback devices may comprise one or more vibration devices, compression devices, electroactive polymers, piezoelectric devices, electrostatic devices, or subsonic audio wave surface actuation devices.

In a sixth example, the plurality of haptic feedback devices may be communicatively coupled together using one or more flexible circuits and enclosed in one or more cavities defined by an inner dimension of the wristband.

In a seventh example, the wristband may comprise a plurality of segments to individually enclose each of the plurality of haptic feedback devices, the plurality of segments coupled together to allow the wristband to flex between the plurality of segments.

In an eighth example, the apparatus may comprise logic to control the plurality of haptic feedback devices individually or as a group to output different navigation commands based on the received navigation information.

In a ninth example, the apparatus may comprise logic to increase or decrease a frequency or intensity of the mechanical representation of the navigation information based on one or more navigation attributes of the navigation information.

In a tenth example, the mechanical representation comprising activation of a predetermined group of the plurality of haptic feedback devices.

In an eleventh example, the apparatus may comprise logic to wireless receive training information from the computing device, the training information comprising mechanical representations of navigation information corresponding to navigation commands.

In a twelfth example, the apparatus may comprise one or more input devices to initiate or terminate navigation, to accept or dismiss navigation information, or to receive training input information, the one or more input devices comprising a mechanical input device, touch input device, gesture input device or voice input device.

In a thirteenth example, a method may comprise receiving, at a wearable navigation device, navigation information from a computing device wirelessly coupled to the wearable navigation device and outputting a mechanical representation of the navigation information using one or more of a plurality of haptic feedback devices arranged around a circumference of the wearable navigation device.

In a fourteenth example, the wearable navigation device comprising a wristband and the plurality of haptic feedback devices comprising one or more vibration devices, compression devices, electroactive polymers, piezoelectric devices, electrostatic devices, or subsonic audio wave surface actuation devices.

In a fifteenth example, the method may comprise receiving orientation information from one or more orientation devices, dynamically determining an orientation of the wearable navigation device in three-dimensional (3D) space based on the received orientation information, and dynamically updating the one or more haptic feedback devices used to output the navigation information based on changes in the orientation of the wearable navigation device.

In a sixteenth example, the method may comprise controlling the plurality of haptic feedback devices individually or as a group to output different navigation commands based on the received navigation information.

In a seventeenth example, the method may comprise increasing or decreasing a frequency or intensity of the mechanical representation of the navigation information based on one or more navigation attributes of the navigation information.

In an eighteenth example, the method may comprise receiving training information from the computing device and updating a mechanical representation of the navigation information based on the received training information.

In a nineteenth example, the method may comprise determining that navigation information from the computing device is temporarily unavailable and outputting an outstanding navigation command based on dead reckoning information received from a dead reckoning device.

In a twentieth example, the method may comprise receiving navigation information indicating that an action is required, simultaneously or sequentially activating one or more of the plurality of haptic feedback devices to indicate what action is required, periodically replaying the activation until the action is required, and decreasing a time between the periodic replaying until the action is imminent.

In a twenty first example, the method may comprise receiving navigation information indicating that an action is required, simultaneously or sequentially activating one or more of the plurality of haptic feedback devices to indicate what action is required, periodically replaying the activation until the action is required and increasing an intensity of the activation until the action is imminent.

In a twenty second example, an article may comprise a non-transitory storage medium containing a plurality of instructions that if executed enable a system to receive, at a wearable navigation device, navigation information from a computing device wirelessly coupled to the wearable navigation device and output a mechanical representation of the navigation information using one or more of a plurality of haptic feedback devices arranged around a circumference of the wearable navigation device.

In a twenty third example, the wearable navigation device comprising a wristband and the plurality of haptic feedback devices comprising one or more vibration devices, compression devices, electroactive polymers, piezoelectric devices, electrostatic devices, or subsonic audio wave surface actuation devices.

In a twenty fourth example, the article may comprise instructions that if executed enable the system to receive orientation information from one or more orientation devices, dynamically determine an orientation of the wearable navigation device in three-dimensional (3D) space based on the received orientation information, and dynamically update the one or more haptic feedback devices used to output the navigation information based on changes in the orientation of the wearable navigation device.

In a twenty fifth example, the article may comprise instructions that if executed enable the system to control the plurality of haptic feedback devices individually or as a group to output different navigation commands based on the received navigation information.

In a twenty sixth example, the article may comprise instructions that if executed enable the system to increase or decrease a frequency or intensity of the mechanical representation of the navigation information based on one or more navigation attributes of the navigation information.

In a twenty seventh example, the article may comprise instructions that if executed enable the system to receive training information from the computing device and update a mechanical representation of the navigation information based on the received training information.

In a twenty eighth example, the article may comprise instructions that if executed enable the system to determine that navigation information from the computing device is temporarily unavailable and output an outstanding navigation command based on dead reckoning information received from a dead reckoning device.

In a twenty ninth example, the article may comprise instructions that if executed enable the system to, receive navigation information indicating that an action is required, simultaneously or sequentially activate one or more of the plurality of haptic feedback devices to indicate what action is required, periodically replay the activation until the action is required, and decrease a time between the periodic replaying until the action is imminent.

In a thirtieth example, the article may comprise instructions that if executed enable the system to receive navigation information indicating that an action is required, simultaneously or sequentially activate one or more of the plurality of haptic feedback devices to indicate what action is required, periodically replay the activation until the action is required, and increase an intensity of the activation until the action is imminent.

Other embodiments are described and claimed.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus, comprising:
a wristband comprising a plurality of haptic feedback devices arranged around a circumference of the wristband; and
logic to wirelessly receive navigation information from a computing device and to output the navigation information using one or more of the plurality of haptic feedback devices, the output comprising a mechanical representation of the navigation information.

2. The apparatus of claim 1, comprising:
one or more orientation devices, the logic to dynamically determine an orientation of the wristband in three-dimensional (3D) space using orientation information received from the one or more orientation devices.

3. The apparatus of claim 2, the logic to dynamically update the one or more haptic feedback devices used to output the navigation information based on changes in the orientation of the wristband.

4. The apparatus of claim 2, the one or more orientation devices comprising one or more of an accelerometer, a gyroscope or a compass.

5. The apparatus of claim 1, the plurality of haptic feedback devices comprising one or more vibration devices, compression devices, electroactive polymers, piezoelectric devices, electrostatic devices, or subsonic audio wave surface actuation devices.

6. The apparatus of claim 1, the plurality of haptic feedback devices communicatively coupled together using one or more flexible circuits and enclosed in one or more cavities defined by an inner dimension of the wristband.

7. The apparatus of claim 1, the wristband comprising a plurality of segments to individually enclose each of the plurality of haptic feedback devices, the plurality of segments coupled together to allow the wristband to flex between the plurality of segments.

8. The apparatus of claim 1, the logic to control the plurality of haptic feedback devices individually or as a group to output different navigation commands based on the received navigation information.

9. The apparatus of claim 1, the logic to increase or decrease a frequency or intensity of the mechanical representation of the navigation information based on one or more navigation attributes of the navigation information.

10. The apparatus of claim 1, the mechanical representation comprising activation of a predetermined group of the plurality of haptic feedback devices.

11. The apparatus of claim 1, the logic to wireless receive training information from the computing device, the training information comprising mechanical representations of navigation information corresponding to navigation commands.

12. The apparatus of claim 1, comprising:
one or more input devices to initiate or terminate navigation, to accept or dismiss navigation information, or to receive training input information, the one or more input devices comprising a mechanical input device, touch input device, gesture input device or voice input device.

13. A method, comprising:
receiving, at a wearable navigation device, navigation information from a computing device wirelessly coupled to the wearable navigation device; and
outputting a mechanical representation of the navigation information using one or more of a plurality of haptic feedback devices arranged around a circumference of the wearable navigation device.

14. The method of claim 13, the wearable navigation device comprising a wristband and the plurality of haptic feedback devices comprising one or more vibration devices, compression devices, electroactive polymers, piezoelectric devices, electrostatic devices, or subsonic audio wave surface actuation devices.

15. The method of claim 13, comprising:
receiving orientation information from one or more orientation devices;
dynamically determining an orientation of the wearable navigation device in three-dimensional (3D) space based on the received orientation information; and
dynamically updating the one or more haptic feedback devices used to output the navigation information based on changes in the orientation of the wearable navigation device.

16. The method of claim 13, comprising:
controlling the plurality of haptic feedback devices individually or as a group to output different navigation commands based on the received navigation information.

17. The method of claim 13, comprising:
increasing or decreasing a frequency or intensity of the mechanical representation of the navigation information based on one or more navigation attributes of the navigation information.

18. The method of claim 13, comprising:
receiving training information from the computing device; and
updating a mechanical representation of the navigation information based on the received training information.

19. The method of claim 13, comprising:
determining that navigation information from the computing device is temporarily unavailable; and
outputting an outstanding navigation command based on dead reckoning information received from a dead reckoning device.

20. The method of claim 13, comprising:
receiving navigation information indicating that an action is required;
simultaneously or sequentially activating one or more of the plurality of haptic feedback devices to indicate what action is required;
periodically replaying the activation until the action is required; and
decreasing a time between the periodic replaying until the action is imminent.

21. The method of claim 13, comprising:
receiving navigation information indicating that an action is required;
simultaneously or sequentially activating one or more of the plurality of haptic feedback devices to indicate what action is required;
periodically replaying the activation until the action is required; and
increasing an intensity of the activation until the action is imminent.

22. An article comprising a non-transitory storage medium containing a plurality of instructions that if executed enable a system to:
receive, at a wearable navigation device, navigation information from a computing device wirelessly coupled to the wearable navigation device; and
output a mechanical representation of the navigation information using one or more of a plurality of haptic feedback devices arranged around a circumference of the wearable navigation device.

23. The article of claim 22, the wearable navigation device comprising a wristband and the plurality of haptic feedback devices comprising one or more vibration devices, compression devices, electroactive polymers, piezoelectric devices, electrostatic devices, or subsonic audio wave surface actuation devices.

24. The article of claim 22, comprising instructions that if executed enable the system to:
receive orientation information from one or more orientation devices;
dynamically determine an orientation of the wearable navigation device in three-dimensional (3D) space based on the received orientation information; and
dynamically update the one or more haptic feedback devices used to output the navigation information based on changes in the orientation of the wearable navigation device.

25. The article of claim 22, comprising instructions that if executed enable the system to:
control the plurality of haptic feedback devices individually or as a group to output different navigation commands based on the received navigation information.

26. The article of claim 22, comprising instructions that if executed enable the system to:
increase or decrease a frequency or intensity of the mechanical representation of the navigation information based on one or more navigation attributes of the navigation information.

27. The article of claim 22, comprising instructions that if executed enable the system to:
receive training information from the computing device; and
update a mechanical representation of the navigation information based on the received training information.

28. The article of claim 22, comprising instructions that if executed enable the system to:
determine that navigation information from the computing device is temporarily unavailable; and
output an outstanding navigation command based on dead reckoning information received from a dead reckoning device.

29. The article of claim 22, comprising instructions that if executed enable the system to:
receive navigation information indicating that an action is required;
simultaneously or sequentially activate one or more of the plurality of haptic feedback devices to indicate what action is required;
periodically replay the activation until the action is required; and
decrease a time between the periodic replaying until the action is imminent.

30. The article of claim 22, comprising instructions that if executed enable the system to:
receive navigation information indicating that an action is required;
simultaneously or sequentially activate one or more of the plurality of haptic feedback devices to indicate what action is required;
periodically replay the activation until the action is required; and
increase an intensity of the activation until the action is imminent.
